(19) United States
(12) Patent Application Publication
(10) Pub. No.: US 2008/0142548 A1
(43) Pub. Date: Jun. 19, 2008

(54) Method and Apparatus for Combination and Delivery of Beverages for Consumption

(75) Inventors: Jason Moen, Gardena, CA (US); Bruce Kirshbaum, Gardena, CA (US)

Correspondence Address: KLEINBERG & LERNER, LLP, 2049 CENTURY PARK EAST, SUITE 1080, LOS ANGELES, CA, 90067, US

(73) Assignee: FROZEN BEVERAGE SERVICES OF CALIFORNIA, INC., Gardena, CA (US)

(21) Appl. No.: 11/610,416

(22) Filed: Dec. 13, 2006

(51) Int. Cl. B67D 5/56

(52) U.S. Cl. 222/129.1; 137/9; 137/606

(57) ABSTRACT

A combination unit including pre-set flow regulators and pressurization pumps combines drinks in pre-determined ratios. A common pressure source sends a base liquid through a first regulator and a mix liquid through a second regulator the outputs of which are thereby combined to be served using a dispenser.

### BACKGROUND

1. Field of the Invention

The present invention relates to drink combination and dispensing and more particularly to a method and apparatus for combining and delivery of beverages for consumption.

2. Description of the Related Art

There exist other methods and apparatus whereby drinks may be combined and delivered. Most of these methods, for example for carbonated beverages, require a “mixing head” at the point of delivery. Alternative methods require heavy and large canisters or boxes of the contents to be combined. Still other methods provide for the use of regulators, valves and complicated meters for measuring the content to be combined exactly.

In the field of alcoholic beverages, the user of a method and apparatus for combining drinks, typically a bar or concessionaire, is keenly interested in maintaining control over the amount of alcohol versus flavoring (for mixed drinks) that is provided. For example, a bar owner may only wish for 4 ounces of alcohol to be combined with 12 ounces of a particular flavoring. The methods of the prior art typically provide gauges and regulating reservoirs whereby the amount of each part of the combination may be measured prior to it being combined. These gauges can be reviewed by the bar owner (or employees) and the combination altered.

Still other prior art simply combines the two or more elements to be combined arbitrarily or half-and-half, caring little for exact measurements. These systems typically use substantially similar pressure on the two or more elements to push them together once a lever is used requesting beverage. Because they are at roughly equal pressure, the contents are combined, roughly equally. This concept is simple, but it lacks the control of the method and apparatus described herein.

### SUMMARY OF THE INVENTION

The invention provides a method and apparatus for the combination and delivery of beverages for consumption. The invention provides means by which two or more liquids for consumption together may be combined in pre-determined amounts. The method and apparatus of this invention involves the use of flow meters or flow regulators to regulate, at a pre-set level, the amount of two or more liquids entering a completed combination beverage. Additional means are employed whereby liquid is forced through those flow regulators to a final dispensing output. Furthermore, means are employed for storing the two or more liquids in a convenient and quickly replaceable manner.

The method of this invention improves on the prior art in a number of ways. The unit which combines the two or more liquids is substantially less complicated than the prior art. The invention is capable of being set up one time and need never be adjusted again. The invention provides means by which the individuals actually dispensing the drinks have no opportunity to alter the pre-set combination of liquids. The method and apparatus of this invention further provides that refills may easily be added. Additionally, this invention improves on the prior art by providing ease of use along with stringent controls over the combination amounts of the liquids.

It is an object of the present invention to provide a means by which beverages may be combined quickly and with simple-to-use components. It is a further object of this invention to provide a simpler means for combining and dispensing beverages than has ever been available before in the prior art. It is a further objective of the present invention to ensure consistent amounts of each liquid for any number of combined liquids, so as to maintain quality and integrity of the resulting combination beverage. It is an object of the present invention to accomplish these objects with as few moving parts as possible and as simply as possible, which is also an improvement over any prior art method or apparatus.

The novel features which are characteristic of the invention, both as to structure and method of the operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is a top-down depiction of the combination unit of the invention with the cover removed.

FIG. 2 is a perspective depiction of the combination unit of the invention with the cover removed.

FIG. 3 is a top-down depiction of the combination unit of the invention with the cover in place

FIG. 4 is a perspective depiction of the combination unit of the invention with the cover in place.

FIG. 5 is a top-front depiction of the apparatus of the invention, utilizing three combination units, three sources of mix and three sources of base.

FIG. 6 is a front depiction of the apparatus of the invention, utilizing three combination units, three sources of mix and three sources of base.

FIG. 7 is a schematic depiction of the apparatus of the invention utilizing two combination units, two sources of mix and one source of base.

### DETAILED DESCRIPTION OF THE INVENTION

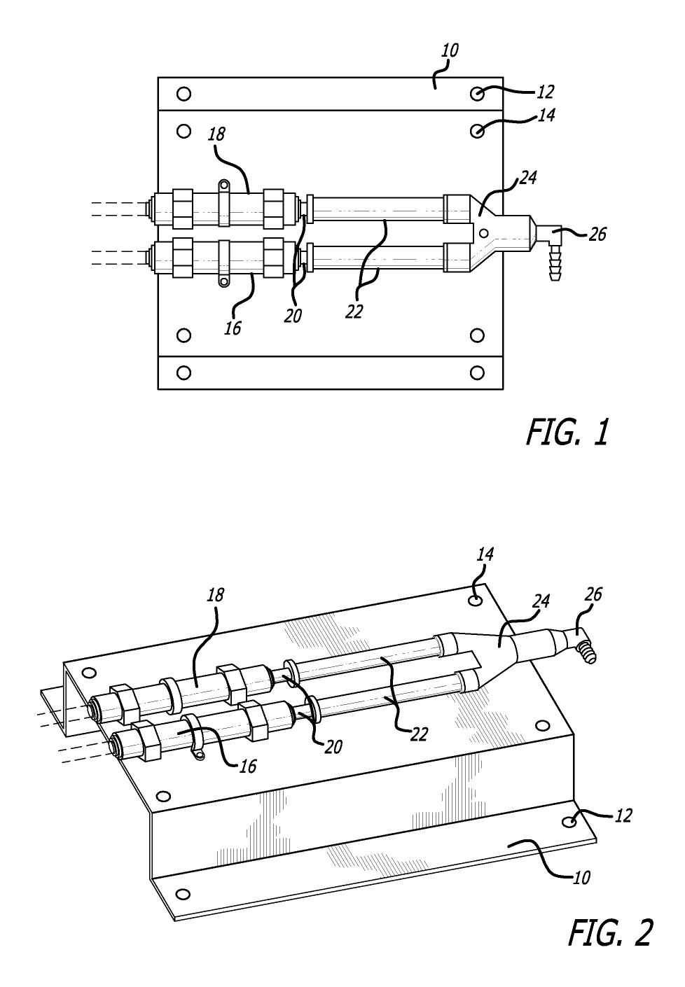

Turning first to FIGS. 1 and 2, a top-down view and perspective view, respectively, of the combination unit with the cover removed of the present invention is shown. The combination unit depicted is mounted on a folded metal sheet 10. This metal sheet 10 in the preferred embodiment, has holes 12 drilled through the metal. These holes 12 are useful for mounting the combination unit onto various flat surfaces. Just above the hole 14 is one of the example folds. It is more apparent in the perspective view described with reference to FIG. 2. Hole 14 and other holes like it are used, in the preferred embodiment, to attach the cover which in this depiction has been removed. Alternatively, there need be no cover at all, but it is present in the preferred embodiment in order to protect the combination unit's hosing and valves from wear, cutting and other external elements.

A flow regulator 16, which is known in the art of automobile engine liquid and air flow regulation, but has not been known or used in the art of beverage mixing. A parallel flow regulator 18 is also shown. In the preferred embodiment, flow regulator 16 is always set to a particular restriction. In fact, the flow restriction provided by flow regulator 16 is generally incapable of being altered by means other than inserting a different flow regulator 16.

Flow regulators, like flow regulator 16, come in various restriction levels. The restriction in the preferred embodiment is 3300 ml/min. In alternative embodiments, any restriction may be used while accomplishing the method and apparatus of this invention. For purposes of example, 3300 ml/min will be used and described throughout this specification, but is not intended to act as a limitation on the breadth of the patent coverage.

Parallel flow regulator 18 is set to any number of restrictions, dependent upon the combination of base and mix that is desired. When the two flow regulators are in use, they are driven by a roughly equivalent pressure pump for each, therefore, a ratio of flow regulator 16 to parallel flow regulator 18 can be determined, thereby determining the combination or how much of each part, mix and base, is in the resulting combination. This is described more fully below.

Also shown in FIG. 1 are connection joins 20 and hoses 22 which connect the two flow regulators, 16 and 18 to a Y-joint 24. The now-regulated amount of each liquid travels through those two hoses 22 to be actually mixed at the Y-joint 24. Furthermore, a connector 26 is attached to a liquid dispensing mechanism of varying types by means of a hose, coupled to the ridged end of connector 26.

Connector 26, in the preferred embodiment, transports the now-combined liquid from the combination unit to the hose of a dispensing unit for serving. In this example, the Y-joint 24 is fused to the connector 26. In alternative embodiments they may be separate. The Y-joint 24 contains a place for a screw. This screw is used to hold the Y-joint 24 to the metal sheet 10. The Y-joint 24 is where the liquids are combined after the predetermined amounts of liquid are sent through the connector 26 to be dispensed by any number of means.

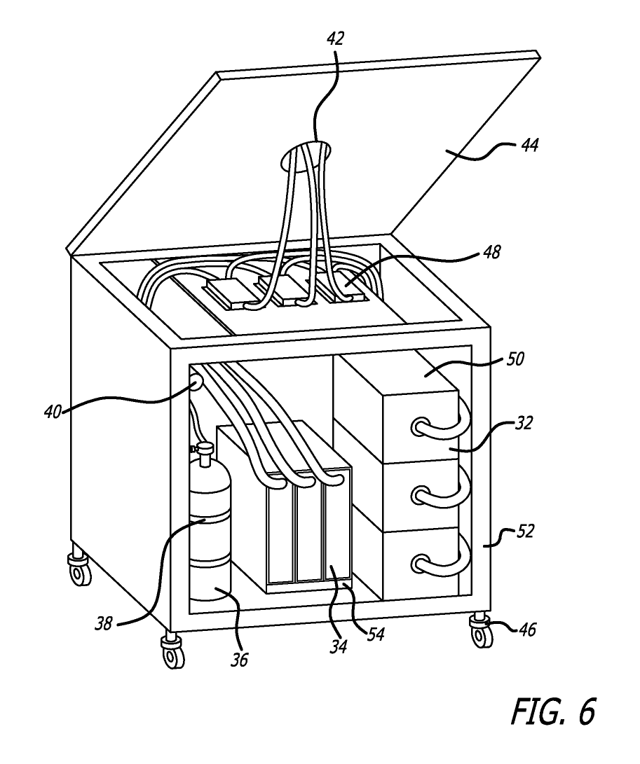

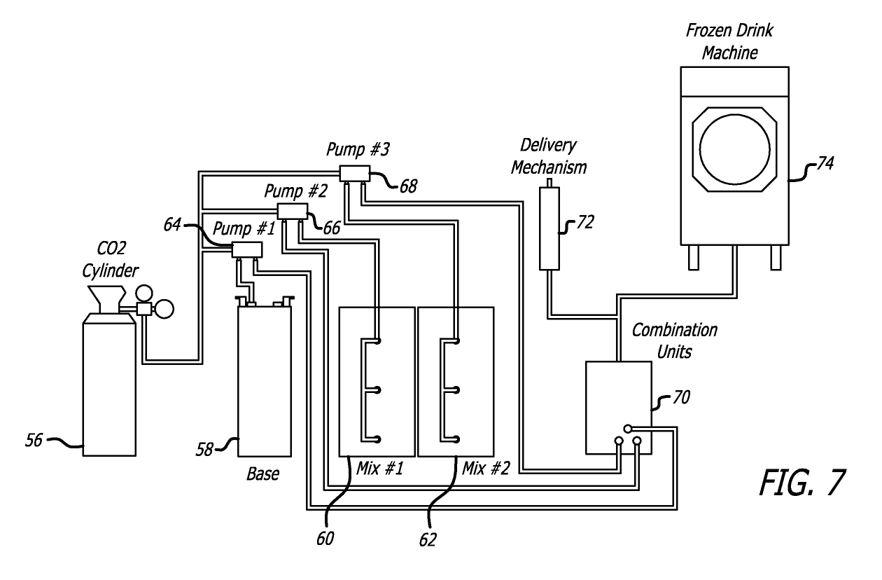

As better seen in FIG. 2, the folded metal sheet 10 creates a raised platform upon which the combination unit may be mounted. In alternative embodiments (see FIGS. 6 and 7), there may be no raised platform and the combination unit(s) may be mounted directly on a metal or other surface. Also visible are holes 14 and holes 12, used for mounting a cover and for mounting the combination unit to a surface, respectfully.

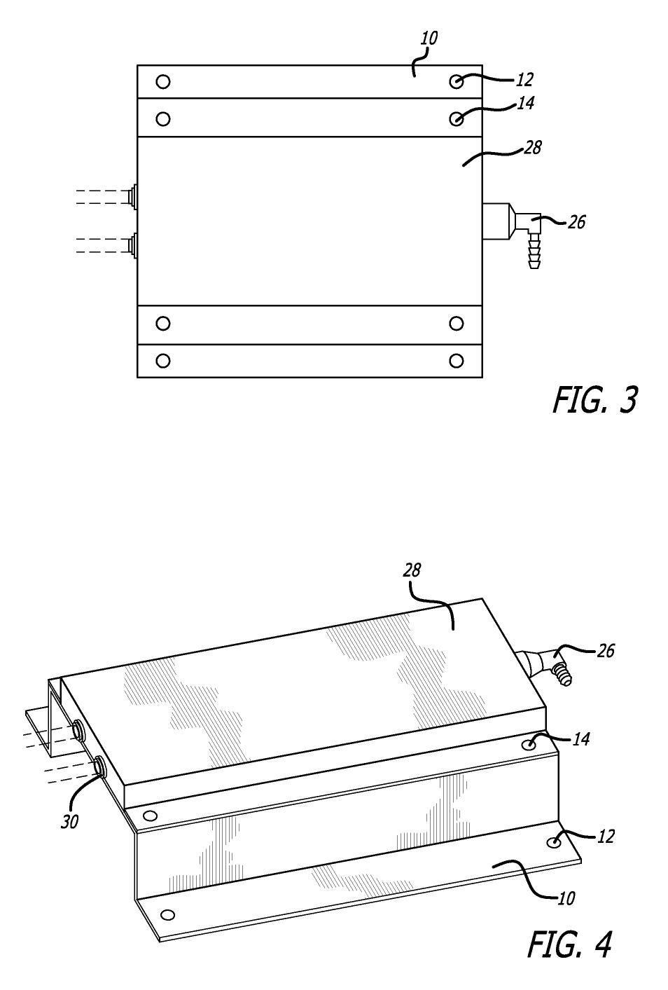

Referring now to FIG. 3, a top-down view of the mixing unit is shown. The combination unit is the same as the one shown in FIG. 1, however now, the cover 28 is affixed to the combination unit. There are also visible the same metal sheet 10, holes 12 and 14 along with the connector 26 as seen in FIG. 1. The cover 28 in the preferred embodiment is also a metal sheet (preferably stainless steel) that is conformed to a rectangular bowl. The top of the cover, is flat with sides bent down to cover the edges. The holes 14 are in use, using screws or rivets to hold the cove 28 in place.

The cover 28 in FIG. 3 has numerous purposes. The first purpose is to protect the components inside the combination unit from dirt and debris. Ideally, once the flow regulator 18 (see FIGS. 1 and 2) is selected for a particular “mix” of the mix and base of the beverage, one need not ever alter the flow regulator. If a user wishes to alter the amount of either mix or base at a later time, the cover 28 would need to be removed and a different flow regulator 18 selected with a different restriction, thereby altering the amounts of both mix and base.

The cover 28 also serves to ensure that users of the method and apparatus of this invention have no opportunity to alter the mix and base quantities for a particular patron or friend. One embodiment of this invention is used to mix an alcoholic base drink with a mix. The mix could be margarita mix and the alcoholic base, tequila. A purchaser of this apparatus would likely be a bar owner. The bar owner hires bartenders. The bartender may have a desire to alter the amounts of alcohol or mix for a particular friend's drink. The cover 28 in conjunction with the use of the pre-set flow regulators 16 and 18 prevents a subsequent operator of this method and apparatus from altering pre-determined levels of each product.

Also, the cover 28 and flow regulators 16 and 18 provide a “foolproof” method of combining drinks. Once the flow regulators 16 and 18 are set and the cover 28 is in place, all a user need do to combine perfect predetermined drinks is utilize an affixed dispenser. The user will have no opportunity to “mess up” an otherwise predetermined amount of mix and base drink. The use of a cover also protects the hoses inside the combination unit from being cut or otherwise damaged.

Referring now to FIG. 4, a perspective view of the combination unit of FIGS. 1 through 3 is depicted with the cover 28 affixed. The holes 14 are being used to hold the cover 28 in place. The holes 12 may be used to affix the combination unit to a surface. The folded metal sheet 10 is also depicted as in previous figures. Finally, the connector 26 is also depicted. Present in this figure is a depiction of the outlet 30. There are holes in the cover 28 to allow the hoses and connectors to escape. In the preferred embodiment, the outlet 30 is not air-tight, but is a cutout around each of the elements which leave or enter the cover 28. In alternative embodiments, the outlet 39 may be airtight or sealed with plastic or calk. This would provide additional protection from dirt and debris.

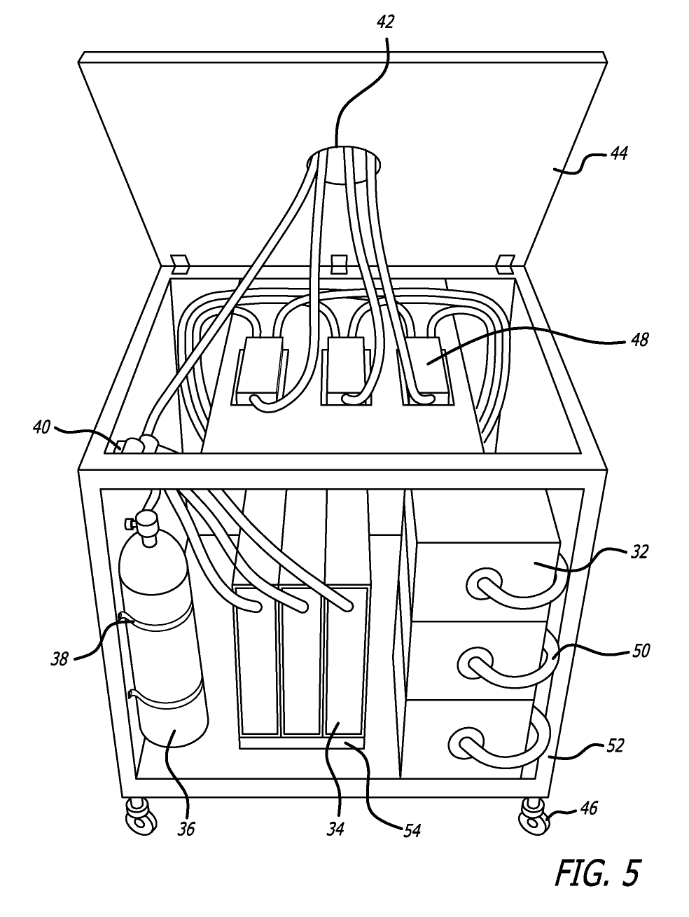

Referring now to FIGS. 5 and 6, respectively, a portable unit 52 embodying the present invention is shown. Depicted in this figure is a portable unit 52. Visible is the back of the unit 52 which is open for easier access to the various components. This unit is mounted on wheels 46. The portable unit 52 is primarily a containment for the elements of the apparatus of this invention.

In the preferred embodiment of the portable unit 52, there is a steel frame with a hinged counter 44. The counter on a hinge also provides additional access to the components of the present invention. There is a wooden or steel floor to the unit for mounting several of the components on. The portable unit may also incorporate mountings for replaceable placards along the two sides and front. In the preferred embodiment, the portable unit's replaceable placards will be used to advertise the beverage being served or to advertise some other element associated with the present purpose of the portable unit 52.

Still referring to FIGS. 5 and 6, respectively, there are numerous elements which make up this invention, they will each be described in turn. First, there is a source or reservoir of mix, a bag in a box (BIB) 32. The BIB 32 is an industry standard for use in rapidly replaceable drinks or drink mixes. The BIB 32 is, as its name suggests, a bag of liquid contained within a box. The box is used primarily to protect the bag from puncture and to make the bag of liquid easier to ship, transport and store. Boxes are much easier to stack than bags filled with liquid. BIBs, like the BIB 32 seen in FIG. 5 may contain concentrated mix (for creating substantially more drink when combined with water or some other diluting liquid. In the preferred embodiment, however, BIB 32 contains already-diluted mix, such that it is ready to be combined directly with a base 34.

There is a rack 50 surrounding the BIB 32 and the other BIBs in the rack 50. The rack 50 of the preferred embodiment is a light weight metal frame. In the preferred embodiment it is coated with a thin layer of plastic to avoid rust and to make the frame less likely to puncture the BIB 32.

Next, there is a base 34 also contained within a reservoir for the drink to be combined. As can be seen from this figure, there are actually three bases 34 contained within reservoirs. Furthermore, there is another rack 54. In the preferred embodiment, the base 34 is held in a plastic container. A hose is connected to the base 34 and runs from the pump 40 to the mixing unit 48 associated with a particular beverage to be combined. Similarly, the BIB 32 is connected with a hose to a pump 40 and subsequently to a mixing unit 48 associated with the mixing of a particular beverage. The rack 54 of this invention has a front lip that holds the plastic container in place and has sides, extending fully above the plastic containers or only partially between them.

Next, a CO₂ container 36 is placed within the portable unit 52. It is held in place by means of straps 38. These straps may be any type of material suitable for holding a large and somewhat heavy metal gas-containment bottle in place. Also depicted is the pump 40. The apparatus as shown may be used to create three different mixed beverages. Therefore, in this embodiment, there are three BIBs 32, three base 34 reservoirs and, correspondingly be three pumps 40. each pump 40 is powered, as is known in the art, by the CO₂ container 36. This enables the unit to run without electricity and without requiring battery or other power.

The pump 40 pushes the two sources of liquids to be combined into the combination unit 48 corresponding to the beverage to be prepared. The pumps apply equal pressure to each of the liquids sent through the mixing unit 48. However, as has been shown in FIGS. 1 and 2, a different flow regulator is used to regulate the amount of that liquid which may actually pass through. In the preferred embodiment the pressure applied by the pumps is 60 pound-force per square inch (PSI). In alternative embodiments, any level of pressure may be used. Once the liquid is mixed it is sent through the opening 42 to be dispensed by any number of means. Dispensing means include spigots, frozen beverage machines, draft towers, fountains and various other means for dispensing the combined liquid.

The apparatus depicted in FIG. 5 is a portable unit 52. This is only one embodiment of the present invention. There are alternative embodiments, such as units mounted in fixed counters behind bars or as small stand alone units for use in concession stands. Alternatively, there may be semi-portable units that require more setup than this portable unit 52, but may be set up and taken down in a few hours for use in conjunction with a stand for use as a temporary concession stand at an event. Any number of configurations are available, not simply the portable unit 52 depicted in FIGS. 5 and 6.

Also depicted in FIGS. 5 and 6 is a unit which uses three sources of base and three sources of mix in conjunction with three combination units. In alternative embodiments any number of combination units, base and mix may be used. In the simplest embodiment, only one base, one mix and one combination unit are employed with a single dispenser. In more complicated embodiments, two bases, one mix and two combination units are employed. In more complicated embodiments still, three bases, two mixes and three combination units are employed. Any number of each element, greater than one mix, one base and one combination unit may be employed using the method and apparatus of this invention.

Referring next to FIG. 7, depiction of an example embodiment which employs a different number of sources of base and mix than the embodiment of FIGS. 5 and 6. This embodiment only has one source of base and two mixes. The components and the ways in which they are connected by hoses are shown in this view.

First, there is a CO₂ cylinder 56 that drives the pumps 1 through 3; elements 64, 66 and 68 respectively. Next there is a base container 58 holding the base. There are Mixes #1 and #2, elements 60 and 62 respectively. There is also depicted, as a single unit, the two mixing units 70 used to mix these elements. Finally, there are two of the various options available for dispensing the combined liquid shown. The first is a traditional bar-like spigot or draft tower delivery mechanism 72. Second, a frozen drink machine 74 is shown. This may be used when the desired drink is a frozen margarita requiring tequila as a base and margarita mix as the mix. Delivering the combined liquid directly to the frozen drink machine 74 for freezing and stirring allows for dispensing of the frozen beverage.

The method of this invention may more easily be understood, with reference to FIG. 7, through use of an example. Once the machine is set up, absent the inclusion of the elements to be combined, a user must select the elements to be combined and their combination ratio. For purposes of an example, FIG. 7 may represent a setup for two types of margaritas. In this example, mix #1 in element 60 would be selected to be a BIB (as described above) containing traditional margarita mix. Mix #2 in element 62 would be selected to be a BIB (as described above) containing a strawberry margarita mix. The base, as is typical for margaritas, would be selected to be tequila. It should be apparent that any number of bases and mixes may be used and of virtually any type.

Once it is determined that two mixes and one base will be used, it is necessary to determine in what amounts or ratios the user of this method and apparatus wishes to use for each portion, base and mix. These amounts will be used to select the flow regulators (described with reference to FIGS. 1 and 2 above) to be used with the present invention. In the preferred embodiment, as also described above, one of the flow regulators always is a 3300 ml/min restriction. Therefore, the user need only select the corresponding flow regulator, for each drink to be made, that creates a certain ratio or base to mix. The following table is an example of flow ratios and resulting combinations of finished mixed drink.

8 oz of Mix/Base
(mix utilizing a 3300 ml/min flow regulator)

| | Amount of Base in | Amount of Mix in |
|---|---|---|
| Base ml Restrictor | Mixed Drink | Mixed Drink |
| 400 ml | 0.67 oz | 7.33 oz |
| 500 ml | 1.00 oz | 7.00 oz |
| 550 ml | 1.13 oz | 6.87 oz |
| 600 ml | 1.21 oz | 6.79 oz |
| 650 ml | 1.31 oz | 6.69 oz |
| 700 ml | 1.37 oz | 6.63 oz |
| 800 ml | 1.50 oz | 6.50 oz |
| 850 ml | 1.55 oz | 6.45 oz |
| 900 ml | 1.75 oz | 6.25 oz |
| 950 ml | 1.81 oz | 6.19 oz |
| 1000 ml | 1.87 oz | 6.13 oz |

The above ratios are reached by dividing the base ml restrictor amount by the mix ml restrictor (in this case 3300 ml) added to the base ml restrictor and then multiplying that by the size of the drink to be made. So, for example, for a 650 ml base restrictor divided by a 3300 ml/min mix restrictor added to the 650 ml base restrictor is 0.1645. Multiplying this value by 8 ounces of mix and base to be made results in the 1.31 ounces depicted in the table above. Subtracting this amount from the total 8 ounces results in the amount of mix, 6.69 ounces, as is also shown in the table above.

Similar tables may be made for any size mix restrictor (not only the 3300 ml/min restrictor) and any size base restrictor. For example, a table for a 16 oz size of mix/base is displayed below, utilizing a 3500 ml/min restrictor.

16 oz of Mix/Base
(mix utilizing a 3500 ml/min flow regulator)

| | Amount of Base in | Amount of Mix in |
|---|---|---|
| Base ml Restrictor | Mixed Drink | Mixed Drink |
| 400 ml | 1.64 oz | 14.36 oz |
| 500 ml | 1.82 oz | 14.18 oz |
| 550 ml | 2.00 oz | 14.00 oz |
| 600 ml | 2.17 oz | 13.83 oz |
| 650 ml | 2.34 oz | 13.66 oz |
| 700 ml | 2.51 oz | 13.49 oz |
| 800 ml | 2.67 oz | 13.33 oz |
| 850 ml | 2.82 oz | 13.18 oz |
| 900 ml | 2.98 oz | 13.02 oz |
| 950 ml | 3.13 oz | 12.87 oz |
| 1000 ml | 3.27 oz | 12.73 oz |

As can be seen, these types of tables may be made for any size restrictor and to enable a beverage seller to select, very precisely, the amount of each portion of a combined beverage is mix and what portion is base. As described above, the method and apparatus of this invention does not allow the concessionaire or other dispenser to easily manipulate the concentration or to fail at combining them appropriately, thereby saving the operator money and hassle.

The present invention utilizes the combination of elements, including the flow regulators, in a way not previously known in the art. The resulting method and apparatus overcomes the limitations of the prior art as to ease of installation, ease of use, inability of employees or bartenders to make mistakes as to the combination of elements and portability. The present invention is much less complicated than other inventions of the prior art utilizing pressure sensors, measurement devices and other elements to properly combine drinks.

Accordingly, a method and apparatus for combination and delivery of beverages for consumption is described. It is to be understood that the foregoing description has been made with respect to specific embodiments thereof for illustrative purposes only. The overall spirit and scope of the present invention is limited only by the following claims, as defined in the foregoing description.

What is claimed is:

1. An apparatus for combination and delivery of beverages for consumption comprising:
a first reservoir for holding a base liquid;
a second reservoir for holding a mix liquid; and
combining means, connected to said first and second reservoirs and including a first flow regulator, for determining the volume from said first reservoir to be combined with the contents of said second reservoir to thereby create a combination beverage.

2. The apparatus of claim 1 further comprising a dispensing mechanism for delivery of said combination beverage to a consumer.

3. The apparatus of claim 1 wherein said base liquid is an alcoholic beverage.

4. The apparatus of claim 1 wherein said mix liquid is a component designed to be combined with an alcoholic beverage to produce said combination beverage.

5. The apparatus of claim 1 wherein said combining means utilize said first flow regulator for the contents of said first reservoir and utilizes a second flow regulator for the contents of said second reservoir.

6. The apparatus of claim 5 wherein said first flow regulator is set to a first predetermined restriction.

7. The apparatus of claim 6 wherein said predetermined restriction is 3300 milliliter per minute.

8. The apparatus of claim 5 wherein said second flow regulator can be chosen based upon its flow restriction.

9. The apparatus of claim 1, further comprising pressurizing means, connected to said first and second reservoirs, for providing pressure sufficient to force the contents of said first and second reservoirs through said combination means.

10. An apparatus for combination and delivery of beverages for consumption comprising:
a first reservoir for holding a base liquid;
a second reservoir for holding a mix liquid;
combinating means, connected to said first and second reservoirs and including a first flow regulator, wherein the contents of each of said first reservoir and said second reservoir pass through to create a combination beverage; and
pressurizing means, connected to said first and second reservoirs and to said combination means, for providing pressure sufficient to force the contents of said first and second reservoirs through said combination means.

11. The apparatus of claim 10, wherein said pressurizing means is at least one pump powered by carbon dioxide.

12. The apparatus of claim 10, wherein said pressurizing means is comprised of:
a first pump, connected to said first reservoir and to said combination means; and
a second pump, connected to said second reservoir and to said combination means.

13. The apparatus of claim 10, wherein said first and second pumps are powered by carbon dioxide.

14. The apparatus of claim 10, wherein said combining means is comprised of:
a second flow regulator, connected to said second reservoir and set at a predetermined restriction, through which the contents of said second reservoir pass; and
said first flow regulator is connected to said first reservoir and set at a predetermined restriction, through which the contents of said first reservoir pass.

15. The apparatus of claim 14, wherein said first flow regulator restriction is set to maintain a basis upon which different ratios of said base liquid to said mix liquid in said combination beverage may be created.

16. The apparatus of claim 15, wherein said second flow regulator may have differing restrictions so as to create different ratios of said base liquid to said mix liquid in said combination beverage.

17. The apparatus of claim 14, wherein said second flow regulator is selected from a group of flow regulators, each having a different restriction, so as to thereby select said second flow regulator for creating a desired ratio of said base liquid to said mix liquid in said combination beverage.

18. A method of combination and delivery of beverage for consumption, comprising the steps of:
selecting a base liquid;
selecting a mix liquid;
determining a desired ratio of said mix liquid to said base liquid;
utilizing a first flow regulator of a predetermined restriction;
utilizing a second flow regulator of a restriction designed to create said desired ratio;
combining said base liquid and said mix liquid according to said desired ratio by routing said base liquid through said first flow regulator and said mix liquid through said second flow regulator to thereby create a combination beverage according to said desired ratio; and
dispensing said combination beverage for consumption.
